(19) United States
(12) Patent Application Publication
(10) Pub. No.: US 2016/0049234 A1
(43) Pub. Date: Feb. 18, 2016

(54) COMMON MODE NOISE FILTER AND MANUFACTURING METHOD THEREOF

(71) Applicant: PANASONIC INTELLECTUAL PROPERTY MANAGEMENT CO., LTD., Osaka-shi, Osaka (JP)

(72) Inventors: TAKUJI KAWASHIMA, Fukui (JP); YOSHIHARU OMORI, Osaka (JP); HIDEKI TANAKA, Fukui (JP)

(21) Appl. No.: 14/784,031

(22) PCT Filed: Apr. 16, 2014
(86) PCT No.: PCT/JP2014/002162

§ 371 Date: Oct. 12, 2015

(30) Foreign Application Priority Data
Apr. 18, 2013 (JP) 2013-087157

(51) Int. Cl. H01F 27/28; H01F 41/04

(52) U.S. Cl. CPC H01F 27/2804; H01F 41/041

(57) ABSTRACT

A common mode noise filter includes: a laminated body; and a first and second coil conductors that are formed inside the laminated body and face each other in a first direction, wherein the first coil conductor has a first surface facing the second coil conductor; the second coil conductor has a second surface facing the first surface; a distance between ends of the first and second surfaces in the first direction is longer than a distance between centers of the first and second surfaces in the first direction; the first and second surfaces have corners each formed into an arcuate shape in a cross section; and a relationship between a height h in the first direction and a width w in a second direction perpendicular to the first direction is h≧w in a cross section of each of the first and second coil conductors.

### TECHNICAL FIELD

The present invention relates to a common mode noise filter for use in digital equipment, AV equipment, and various kinds of electronic equipment such as an information communication terminal, and a method for manufacturing the common mode noise filter.

### BACKGROUND ART

A conventional common mode noise filter includes laminated body 1, two coil conductors 2 and 3 that are formed inside laminated body 1 and face each other, and leading conductors 4 and 5 that are connected to coil conductors 2 and 3, respectively, as shown in FIG. 9. The cross-sectional shape of each of two coil conductors 2 and 3 is square.

PTL 1, for example, has been known as conventional art literature information regarding the invention of this application.

### CITATION LIST

### Patent Literature

PTL 1: Unexamined Japanese Patent Publication No. 2012-89543

### SUMMARY OF THE INVENTION

A common mode noise filter according to the present invention includes: a laminated body; and a first coil conductor and a second coil conductor that are formed inside the laminated body and face each other in a first direction, wherein the first coil conductor has a first surface facing the second coil conductor; the second coil conductor has a second surface facing the first surface; a distance between an end of the first surface and an end of the second surface in the first direction is longer than a distance between a center of the first surface and a center of the second surface in the first direction; the first surface and the second surface have corners each formed into an arcuate shape in a cross section; and a relationship between a height h in the first direction and a width w in a second direction perpendicular to the first direction is h≧w in a cross section of each of the first and second coil conductors.

In a method for manufacturing a common mode noise filter according to the present invention, a common mode noise filter includes a laminated body having a non-magnetic member containing glass therein. The method includes: a first step of forming first and second coil conductors that face each other and are made of mainly silver, inside the non-magnetic member; and a second step of baking the laminated body, wherein a temperature at which the laminated body is baked is higher than a transition temperature of the glass and higher than a softening temperature of silver in the second step.

The common mode noise filter and the method for manufacturing a common mode noise filter according to the present invention enable degradation of a differential signal to be prevented.

### BRIEF DESCRIPTION OF DRAWINGS

FIG. 1 is a cross-sectional view showing a common mode noise filter in a first exemplary embodiment of the present invention.

FIG. 2 is an exploded perspective view showing laminated body 11 of the common mode noise filter in the first exemplary embodiment of the present invention.

FIG. 3 is a perspective view showing the common mode noise filter in the first exemplary embodiment of the present invention.

FIG. 4 is an enlarged cross-sectional view showing essential parts of the common mode noise filter in the first exemplary embodiment of the present invention.

FIG. 5 is an enlarged cross-sectional view showing essential parts of a conventional common mode noise filter shown in FIG. 9.

FIG. 6 is an enlarged cross-sectional view showing essential parts of the common mode noise filter in a second exemplary embodiment of the present invention.

FIG. 7 is an enlarged cross-sectional view showing essential parts of the common mode noise filter in a third exemplary embodiment of the present invention.

FIG. 8 is an enlarged cross-sectional view showing essential parts of the common mode noise filter in the third exemplary embodiment of the present invention.

FIG. 9 is a cross-sectional view showing a conventional common mode noise filter.

### DESCRIPTION OF EMBODIMENTS

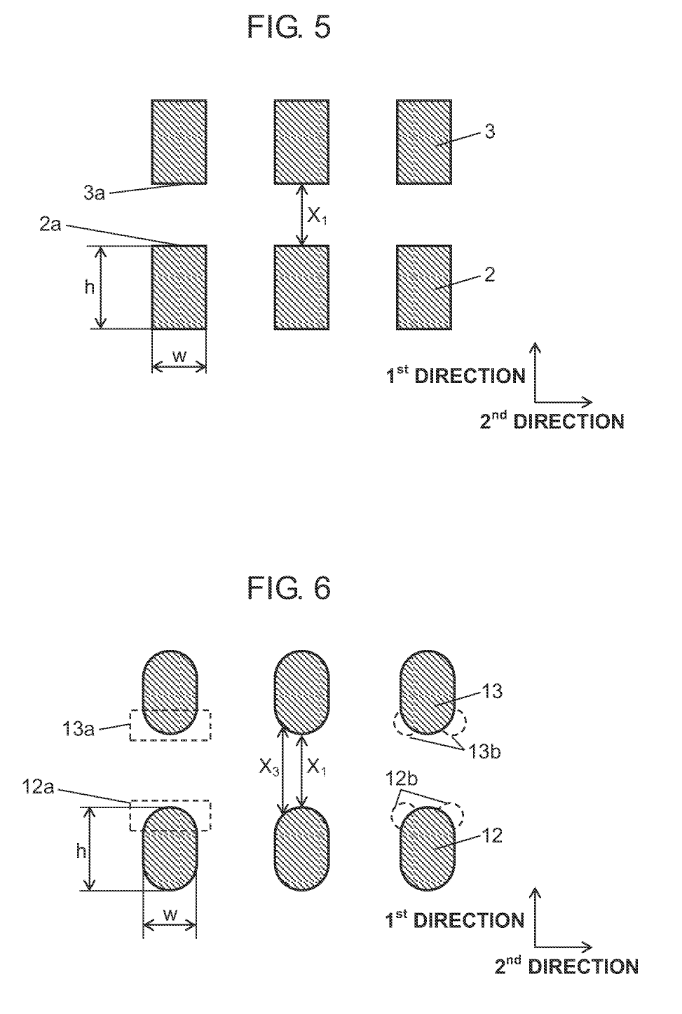

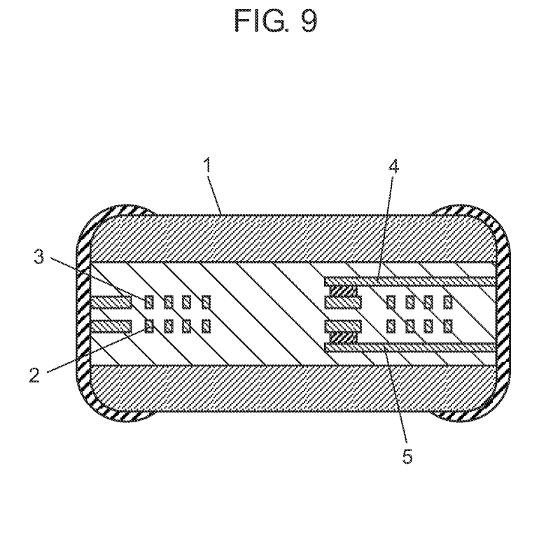

Prior to the description of exemplary embodiments of the present invention, a description will be given below of a problem to be solved experienced by the conventional common mode noise filter explained with reference to FIG. 9. FIG. 5 is an enlarged cross-sectional view showing coil conductors 2 and 3.

If the conventional common mode noise filter is reduced in thickness, a distance between coil conductors 2 and 3 that face each other is short. If the distance between coil conductors 2 and 3 that face each other is short, a capacity generated between coil conductors 2 and 3 is increased, so that a characteristic impedance is reduced. If the characteristic impedance is reduced, a defined characteristic impedance in accordance with each of communication standards cannot be achieved, thereby possibly degrading a differential signal.

A description will be given below of a common mode noise filter capable of preventing a differential signal from being degraded and a method for manufacturing the common mode noise filter.

The same constituent elements in exemplary embodiments are designated by the same reference numerals, and therefore, their detailed description thereof will be omitted.

### FIRST EXEMPLARY EMBODIMENT

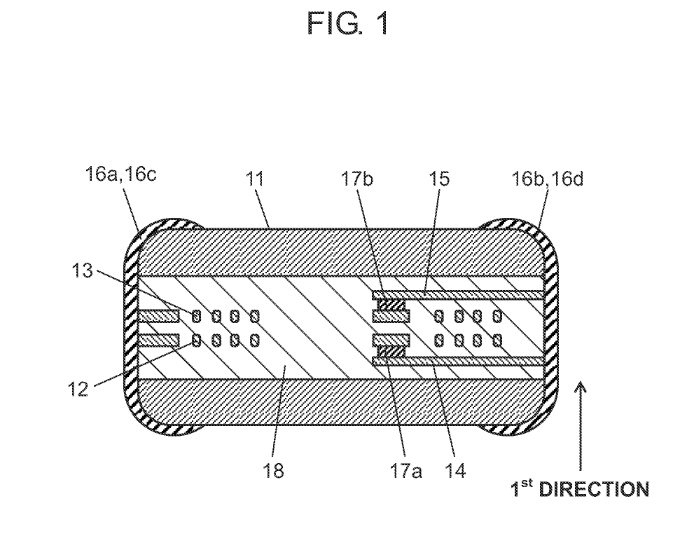

A description will be given of a first exemplary embodiment with reference to FIGS. 1 to 4.

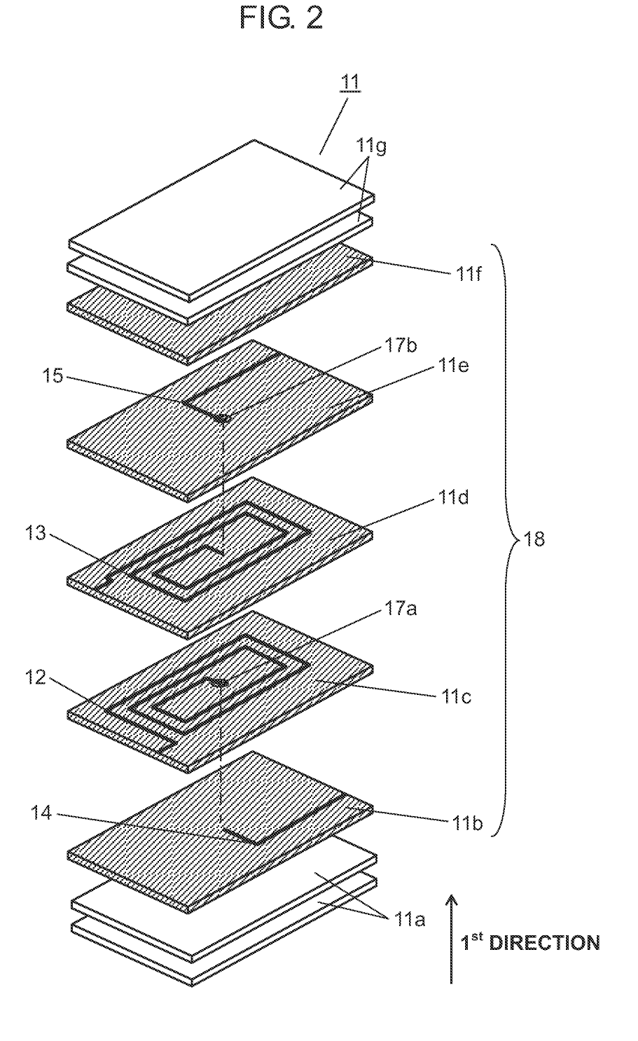

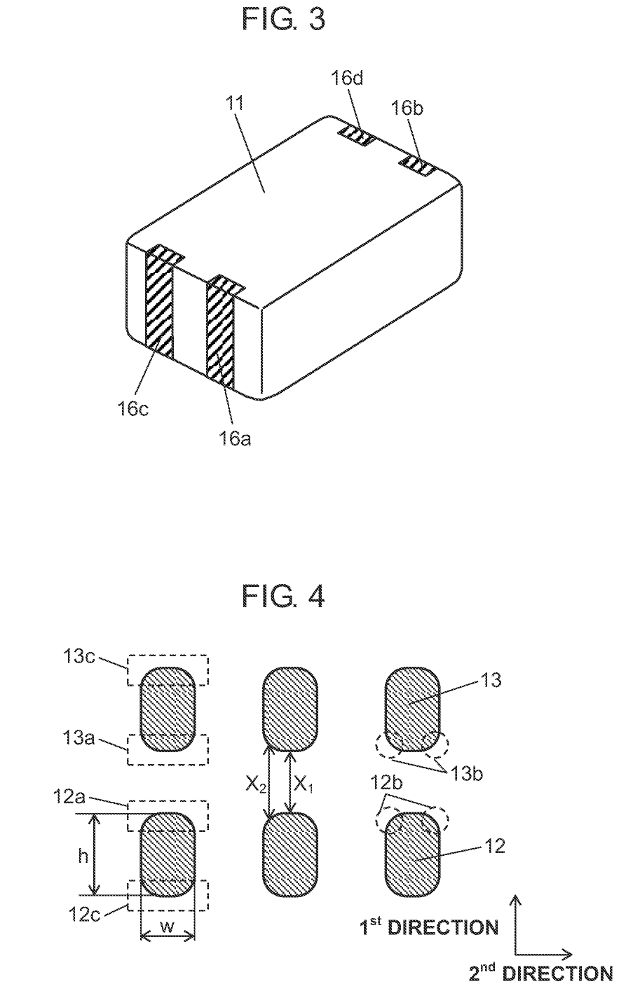

FIG. 1 is a cross-sectional view showing a common mode noise filter; FIG. 2 is an exploded perspective view showing laminated body 11 of the common mode noise filter; FIG. 3 is a perspective view showing the common mode noise filter; and FIG. 4 is an enlarged cross-sectional view showing essential parts of the common mode noise filter.

As shown in FIG. 1, a common mode noise filter in the first exemplary embodiment includes laminated body 11, and first and second coil conductors 12 and 13 that are formed inside laminated body 11 and face each other in a vertical direction (i.e., a first direction). As shown in FIG. 4, the relationship between width w and height h is h>w in the cross section of each of first and second coil conductors 12 and 13. Corners 12b and 13b are arcuate in the cross sections of surfaces 12a and 13a at which first and second coil conductors 12 and 13 face each other. In the present exemplary embodiment, corners in the cross sections of surfaces 12c and 13c opposite to surfaces 12a and 13a at which first and second coil conductors 12 and 13 face each other also are arcuate. All of the corners of first and second coil conductors 12 and 13 are arcuate in the cross section. However, the corners of surfaces 12c and 13c need not always arcuate in the cross section. The corners of surfaces 12c and 13c may be square in the cross section, as shown in FIG. 5. The same goes for second and third exemplary embodiments below. Next, the configuration of laminated body 11 will be described with reference to FIGS. 2 and 3.

As shown in FIG. 2, laminated body 11 includes: first to seventh insulating layers 11a to 11g; first coil conductor 12 formed on third insulating layer 11c; second coil conductor 13 formed on fourth insulating layer 11d; first leading conductor 14 that is formed on second insulating layer 11b and connected to first coil conductor 12; and second leading conductor 15 that is formed on fifth insulating layer 11e and connected to second coil conductor 13.

As shown in FIG. 3, outside electrodes 16a to 16d are formed at both ends of laminated body 11.

First coil conductor 12 is connected to outside electrode 16a; second coil conductor 13, to outside electrode 16c; first leading conductor 14, to outside electrode 16b; and second leading conductor 15, to outside electrode 16d.

First coil conductor 12 is connected to first leading conductor 14 via first via electrode 17a, thus constituting one coil. In the meantime, second coil conductor 13 is connected to second leading conductor 15 via second via electrode 17b, thus constituting another coil.

Although each of first leading conductor 14 and second leading conductor 15 has the combination of linear shapes in FIG. 2, first leading conductor 14 and second leading conductor 15 may have other shapes such as a spiral shape.

Moreover, although first leading conductor 14 and second leading conductor 15 are formed on different insulating layers 11b and 11e, respectively, in FIG. 2, the positions of first leading conductor 14 and second leading conductor 15 are not limited to an example shown in FIG. 1. For example, first leading conductor 14 and second leading conductor 15 may be formed on the same insulating layer. Alternatively, the positions of first leading conductor 14 and second leading conductor 15 may be reverse. First coil conductor 12 and first leading conductor 14 may be interposed between second coil conductor 13 and second leading conductor 15.

First to seventh insulating layers 11a to 11g are formed into a sheet-like shape, and are laminated from bottom in sequence in the first direction. Second to sixth insulating layers 11b to 11f are made of a nonmagnetic material containing glass such as glass ceramic. In contrast, first and seventh insulating layers 11a and 11g are made of a magnetic material such as Cu—Ni—Zn ferrite. First and second coil conductors 12 and 13 are disposed inside nonmagnetic member 18 consisting of second to sixth insulating layers 11b to 11f.

Here, the number of first to seventh insulating layers 11a to 11g is not limited to that shown in FIG. 1. Furthermore, first and second leading conductors 14 and 15 may be brought into contact with insulating layers (such as 11a and 11g) made of a magnetic material.

First and second coil conductors 12 and 13 are formed by spirally plating or printing a silver conductive material on insulating layers 11c and 11d, respectively. Furthermore, first and second coil conductors 12 and 13 face each other in the first direction while holding fourth insulating layer 11d therebetween. Specifically, first and second coil conductors 12 and 13 are disposed in such a manner as to overlap except for both ends thereof, as viewed from the top. First and second coil conductors 12 and 13 are magnetically coupled to each other in the same winding direction.

First and second coil conductors 12 and 13 may be formed into not a spiral shape but other shapes such as a helical shape. Additionally, first and second coil conductors 12 and 13 may be made of not silver but an alloy containing mainly silver such as silver palladium or silver containing glass.

As shown in FIG. 4, the cross section of each of first and second coil conductors 12 and 13 is a substantial rectangle elongated in a lamination direction (i.e., the first direction), in which the relationship between width w and height h is h>w. The shape of each of corners 12b and 13b is arcuate in the cross section of each of surfaces 12a and 13a at which first and second coil conductors 12 and 13 face each other. Here, the height signifies a length in the lamination direction (i.e., the first direction); and the width signifies a length in a direction perpendicular to the lamination direction (i.e., a second direction).

Incidentally, corners 12b and 13b of first and second coil conductors 12 and 13 are arcuate except for first and second leading conductors 14 and 15 and portions to be connected to outside electrodes 16a to 16d.

A description will be given below of a capacity generated in the common mode noise filter in the first exemplary embodiment such configured as described above.

The cross sections of respective corners 12b and 13b of first and second coil conductors 12 and 13 shown in FIG. 4 are arcuate in the cross section of surfaces 12a and 13a that face each other. Consequently, distance X2 between first coil conductor 12 and second coil conductor 13 at corners 12b and 13b is longer than distance X1 between first coil conductor 12 and second coil conductor 13 at the centers of surfaces 12a and 13a. Incidentally, distance X2 between first coil conductor 12 and second coil conductor 13 at corners 12b and 13b signifies a distance between first coil conductor 12 and second coil conductor 13 at respective ends of the surfaces at which first coil conductor 12 and second coil conductor 13 face each other in the first direction. In comparison with a case where surfaces 2a and 3a facing each other are flat, as shown in FIG. 5, a capacity generated between first coil conductor 12 and second coil conductor 13 can be reduced in the exemplary embodiment shown in FIG. 4. Thus, it is possible to increase a characteristic impedance. As a consequence, the characteristic impedance can be adjusted to a defined characteristic impedance in accordance with each of communication standards, thus producing an effect that the degradation of a differential signal can be prevented.

Subsequently, explanation will be made on the capacity generated between first and second coil conductors 13 in more detail.

As shown in FIG. 5, in a case where the cross sectional shape of each of first and second coil conductors 2 and 3 is rectangular, the distance between first coil conductor 2 and second coil conductor 3 is the same at every position between opposite surfaces 2a and 3a. Moreover, the thickness of fourth insulating layer 11d (shown in FIG. 2) between first and second coil conductors 12 and 13 shown in FIG. 4 is assumed to be the same as that of a fourth insulating layer (not shown) between first and second coil conductors 2 and 3 shown in FIG. 5. In this case, although in the common mode noise filter in the first exemplary embodiment shown in FIG. 4, distance X1 between first and second coil conductors 12 and 13 at portions other than corners 12b and 13b that are formed into an arcuate shape (e.g., center portions) is the same as that in the common mode noise filter shown in FIG. 5, distance X2 between first and second coil conductors 12 and 13 at positions between corners 12b and 13b that are formed into an arcuate shape is longer than distance X1. As a consequence, corners 12b and 13b that are formed into an arcuate shape can reduce a capacity generated between opposite portions. Here, distance X2 between first and second coil conductors 12 and 13 at corners 12b and 13b also signifies a distance between first and second coil conductors 12 and 13 at ends of surfaces at which first and second coil conductors 12 and 13 face each other in the first direction.

Thus, it is possible to prevent a signal from being degraded without any reflection or loss of the signal as long as a characteristic impedance falls within a defined range in accordance with each of communication standards in a common mode noise filter disposed on a transmission line (e.g., a characteristic impedance on a transmission line is 90 Ω±15% in the case of USB 2.0). Since the characteristic impedance is proportional to √(L/C) (wherein L designates an inductance value of a coil per unit length of a transmission line and C designates a capacity generated between coils per unit length), in a case where the thickness of insulating layer 11d (i.e., the distance between first and second coil conductors 12 and 13) is, for example, 1 μm to 10 μm because the height of a product is low, the common mode noise filter which is shown in FIG. 5 and in which the cross-sectional shape of each of first and second coil conductors 2 and 3 is rectangular has a higher capacity between first coil conductor 2 and second coil conductor 3 in comparison with the common mode noise filter in the present exemplary embodiment shown in FIG. 4. The configuration shown in FIG. 5 cannot adjust the characteristic impedance to a defined one in accordance with each of communication standards, thereby possibly failing to prevent a differential signal from being degraded.

In contrast, the long distance between first and second coil conductors 12 and 13 at corners 12b and 13b in the present exemplary embodiment shown in FIG. 4 can reduce a capacity generated between first and second coil conductors 12 and 13 more than a capacity generated between first and second coil conductors 2 and 3 even if the cross-sectional area of coil conductors 12 and 13 shown in FIG. 4 is the same as that of coil conductors 2 and 3 shown in FIG. 5. As a consequence, a characteristic impedance can be increased so as to prevent a differential signal from being degraded in the present exemplary embodiment. Furthermore, a magnetically coupled state between first and second coil conductors 12 and 13 can be reduced. Therefore, a non-coupled residual inductor component remains in a differential mode, so that a residual inductance can be increased in the differential mode, thus increasing the characteristic impedance.

Additionally, in the present exemplary embodiment, the capacity generated between first and second coil conductors 12 and 13 can be reduced, and therefore, a common mode noise can be removed even in a high frequency band.

Incidentally, a method for reducing a thickness of a coil conductor so as to increase a self impedance or reducing the width of a coil conductor so as to reduce a capacity generated between coil conductors may be conceived in order to increase the characteristic impedance. However, the method unfavorably increases a DC resistance. In the common mode noise filter in the present exemplary embodiment, the thickness or width of the coil conductor is hardly changed, and therefore, a DC resistance cannot be increased.

In addition, in the common mode noise filter in the present exemplary embodiment, the arcuate portions of corners 12b and 13b can release a stress that is applied to first and second coil conductors 12 and 13 during lamination, thus preventing inter-layer peeling even if each of first and second coil conductors 12 and 13 is thick. Thus, even if a pitch between first and second coil conductors 12 and 13 is reduced, delamination or short-circuiting can be prevented.

Moreover, in the common mode noise filter in the present exemplary embodiment, the capacity generated between first and second coil conductors 12 and 13 can be reduced, and therefore, the frequency of a passing band due to the capacity can be prevented from being reduced.

### SECOND EXEMPLARY EMBODIMENT

Next, a common mode noise filter in a second exemplary embodiment will be described with reference to FIG. 6.

FIG. 6 is a cross-sectional view showing essential parts of the common mode noise filter in the second exemplary embodiment of the present invention.

Incidentally, the same constituent elements in the second exemplary embodiment of the present invention as those in the above-described first exemplary embodiment are designated by the same reference numerals, and therefore, detailed description thereof will be omitted.

A difference between the second exemplary embodiment shown in FIG. 6 and the first exemplary embodiment shown in FIG. 4 resides in that only corners 12b and 13b in FIG. 4 are formed into an arcuate shape whereas cross sections of first and second coil conductors 12 and 13 all are arcuate at surfaces 12a and 13a of first and second coil conductors 12 and 13 that face each other in the second exemplary embodiment shown in FIG. 6. In the present exemplary embodiment, a center on an upper side of the cross section of first coil conductor 12 projects upward whereas a center on a lower side of the cross section of second coil conductor 13 projects downward.

Incidentally, although in the present exemplary embodiment, the cross-sectional shape of each of surfaces 12a and 13a is semi-circular, the cross-sectional shape of each of surfaces 12a and 13a may be circular or elliptical. In the case of a circle, the diameter of an arcuate portion is equal to or greater than width w of each of first and second coil conductors 12 and 13.

With a configuration in the present exemplary embodiment shown in FIG. 6, a distance between respective surfaces 12a and 13a of first and second coil conductors 12 and 13 that face each other is longer at almost every portion (e.g., X3) except for a center than that in the case of the rectangular shape shown in FIG. 5.

Moreover, in the present exemplary embodiment, distance X3 between first coil conductor 12 and second coil conductor 13 at corners 12b and 13b can be further increased in comparison with the first exemplary embodiment shown in FIG. 4. Here, distance X3 between first coil conductor 12 and second coil conductor 13 at corners 12b and 13b also signifies a distance between first coil conductor 12 and second coil conductor 13 at ends at which first coil conductor 12 and second coil conductor 13 face each other in a first direction.

In this manner, a capacity generated between first coil conductor 12 and second coil conductor 13 can be further reduced, and therefore, a characteristic impedance can be further increased. As a consequence, the characteristic impedance can be adjusted to a defined characteristic impedance in accordance with each of communication standards, thus securely preventing the degradation of a differential signal.

### THIRD EXEMPLARY EMBODIMENT

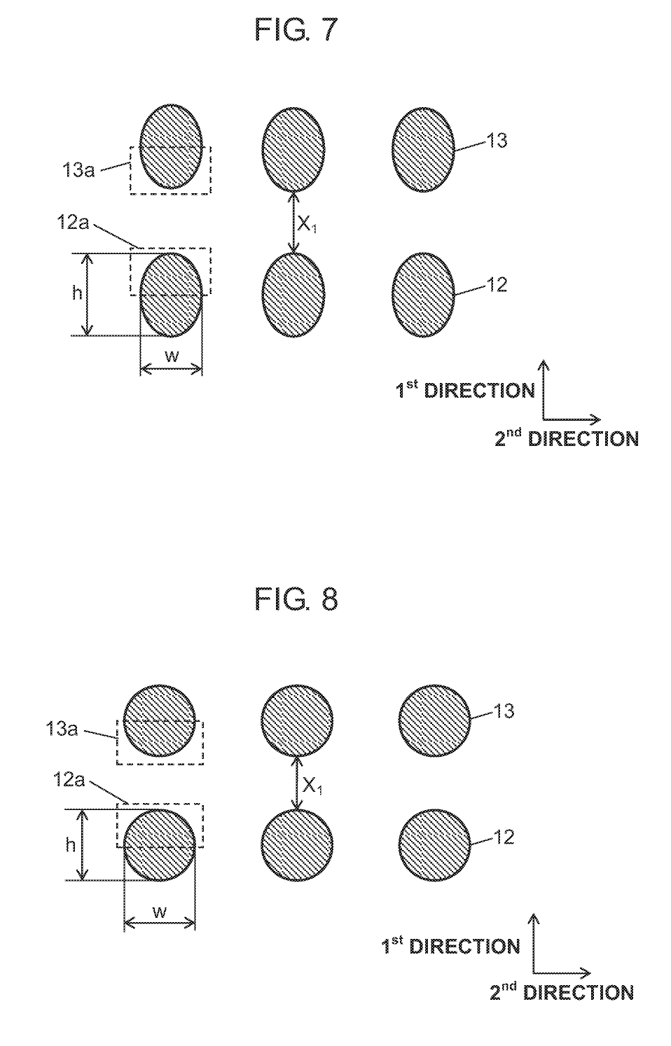

A description will be given of a third exemplary embodiment according to the present invention with reference to FIGS. 7 and 8.

In the third exemplary embodiment shown in FIG. 7, a cross-sectional shape is a vertical ellipse in which the relationship between width w and height h is h>w.

As shown in FIG. 8, a cross-sectional shape may be a substantial circle in which the relationship between width w and height h is h=w.

In the exemplary embodiments shown in FIGS. 4 and 6, edges exist as connecting portions between linear portions and arcuate portions. A stress is concentrated on the edge portions. In contrast, in the third exemplary embodiment shown in FIGS. 7 and 8, there is neither a linear portion nor an edge portion in cross section.

Thus, it is possible to satisfactorily alleviate a stress to be applied to first and second coil conductors 12 and 13 during lamination, so as to effectively prevent inter-layer peeling.

Incidentally, like the first exemplary embodiment, the same cross-sectional area as that of each of first and second rectangular coil conductors 2 and 3 shown in FIG. 5 is achieved by defining width w and height h of first and second coil conductors 12 and 13 in the second and third exemplary embodiments, thus preventing a DC resistance from being increased.

### <Method For Manufacturing Common Mode Noise Filter>

Next, explanation will be made on a method for manufacturing a common mode noise filter in the first to third exemplary embodiments of the present invention.

First, as shown in FIG. 1, laminated body 11 provided with non-magnetic member 18 containing glass is formed.

In forming laminated body 11, first and second coil conductors 12 and 13 that face each other in the vertical direction (i.e., the first direction) and are made of silver are formed inside non-magnetic member 18. At this time, the cross-sectional shape of each of first and second coil conductors 12 and 13 is a substantial rectangle elongated in the vertical direction such that the relationship between width w and height h is h>w.

Next, laminated body 11 is baked.

Laminated body 11 is baked at about 970° C. to 1000° C. This temperature is higher than a glass transition temperature (about 800° C.) and higher than a softening point of silver (about 960° C.).

Finally, outside electrodes 16a to 16d are formed at both ends of the laminated body.

In the above-described method, the temperature at which laminated body 11 is baked is higher than the glass transition temperature, and therefore, the fluidity of non-magnetic member 18 containing glass is increased. Thus, the shape of each of first and second coil conductors 12 and 13 inside laminated body 11 can be easily fluctuated. Moreover, the temperature at which laminated body 11 is baked is higher than the softening temperature of silver, and therefore, first and second coil conductors 12 and 13 made of silver are deformed in such a manner that their surface areas are reduced, so that the cross-sectional shape of each of first and second coil conductors 12 and 13 is deformed into an arcuate shape.

Incidentally, even if first and second coil conductors 12 and 13 are made of not silver but an alloy such as silver palladium containing mainly silver or silver containing glass, the same effect can be produced.

In the method in the present exemplary embodiment, the cross section of each of first and second coil conductors 12 and 13 is the shape described by way of the first to third exemplary embodiments.

In the method in the present exemplary embodiment, it is unnecessary to prepare a coil conductor having a special cross section such as an arcuate shape in advance. In the method for the common mode noise filter in the present exemplary embodiment, the cross section of the coil conductor can be easily formed into an arcuate shape after laminating and baking.

Next, referring to FIG. 4, an effect will be explained in a case where the corners in the cross sections of surfaces 12c and 13c at which first and second coil conductors 12 and 13 do not face each other are formed into an arcuate shape.

In a case where first and second coil conductors 12 and 13 are formed into a vertically elongated shape in the thickness direction, a stress to be applied to each of first and second coil conductors 12 and 13 during the lamination can be alleviated even at surfaces 12c and 13c at which first and second coil conductors 12 and 13 do not face each other. Thus, it is possible to prevent inter-later peeling in the present exemplary embodiment.

Furthermore, as shown in, for example, FIG. 4, if the cross sections of first and second coil conductors 12 and 13 are linearly symmetric with respect to the vertical center, magnetic fluxes generated at first and second coil conductors 12 and 13 are uniform inside laminated body 11, thus preventing any degradation of characteristics such as a common mode noise removing characteristic.

Here, the relationship between width w and height h in cross-sectional shape of each of first and second coil conductors 12 and 13 may be h<w in terms of the reduction of a capacity generated between first coil conductor 12 and second coil conductor 13 owing to the longer distance between first coil conductor 12 and second coil conductor 13 or the prevention of generation of delamination. In this case, there is a fear that a line-to-line distance between first and second coil conductors 12 and 13 is reduced to induce short-circuiting. In view of this, it is preferable that h≧w.

Additionally, although only one pair of first and second coil conductors 12 and 13 is provided in the first to third exemplary embodiments, two or more pairs may be provided in an array manner.

### INDUSTRIAL APPLICABILITY

The common mode noise filter and the method for manufacturing a common mode noise filter according to the present invention can prevent a differential signal from being degraded. In particular, the common mode noise filter and the method for manufacturing a common mode noise filter according to the present invention are useful for a common mode noise filter or the like used for noise measures in digital equipment, AV equipment, and various kinds of electronic equipment such as an information communication terminal.

### REFERENCE MARKS IN THE DRAWINGS

11: laminated body
11a to 11g: insulating layer
12: first coil conductor
12a and 12c: surface
12b: corner
13: second coil conductor
13a and 13c: surface
13b: corner
14 and 15: leading conductor
16a to 16d: outside electrode
17a and 17b: via electrode
18: non-magnetic member

1. A common mode noise filter comprising:
a laminated body; and
a first coil conductor and a second coil conductor that are formed inside the laminated body and face each other in a first direction,
wherein
the first coil conductor has a first surface facing the second coil conductor,
the second coil conductor has a second surface facing the first surface,
a distance between an end of the first surface and an end of the second surface in the first direction is longer than a distance between a center of the first surface and a center of the second surface in the first direction,
corners of each of the first surface and the second surface are formed into an arcuate shape in a cross section, and
a relationship between a height h in the first direction and a width w in a second direction perpendicular to the first direction is h≧w in a cross section of each of the first and second coil conductors.

2. The common mode noise filter according to claim 1, wherein all corners of the first and second coil conductors are formed into an arcuate shape in the cross section.

3. The common mode noise filter according to claim 1, wherein each of the first surface of the first coil conductor and the second surface of the second coil conductor is formed into an arcuate shape in the cross section.

4. The common mode noise filter according to claim 1, wherein a cross-sectional shape of each of the first coil conductor and the second coil conductor is either elliptical or circular.

5. A method for manufacturing a common mode noise filter including a laminated body having a non-magnetic member containing glass, the method comprising:
a first step of forming first and second coil conductors that face each other and are made of mainly silver, inside the non-magnetic member; and
a second step of baking the laminated body,
wherein a temperature at which the laminated body is baked is higher than a transition temperature of the glass and higher than a softening temperature of silver in the second step.

6. The method for manufacturing a common mode noise filter according to claim 5, wherein the first and second coil conductors are made of silver.
